(19) United States
(12) Patent Application Publication
(10) Pub. No.: US 2005/0057778 A1
(43) Pub. Date: Mar. 17, 2005

(54) Data processing apparatus and data processing method

(75) Inventors: Takeshi Morikawa, Takarazuka-shi (JP); Masaya Hashimoto, Amagasaki-shi (JP); Nobuo Kamei, Amagasaki-shi (JP); Daisuke Sakiyama, Maizuru-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc.

(21) Appl. No.: 10/730,110

(22) Filed: Dec. 9, 2003

(30) Foreign Application Priority Data
Aug. 22, 2003 (JP) 2003-298383

(51) Int. Cl. H04N 1/21

(52) U.S. Cl. 358/296

(57) ABSTRACT

A data processing apparatus is provided with an image reader for reading an original, a receiver capable of receiving an external job transmitted from an outside, a transmitter capable of transmitting image data of the original read by the image reader as a scanning job to an outside, a print device for printing data of the external job received by the receiver, one or a plurality of compressing/expanding devices for compressing the image data of the scanning job or the data of the external job and expanding the compressed data, an operation device for instructing an activation of the scanning job in accordance with an operation of a user, and a controller. The controller discriminates whether an activation instruction of the scanning job is made by the operation device or from an outside in cases where a request for processing data of the scanning job by the compressing/expanding devices is made when the data of the external job is being currently compressed or expanded by the compressing/expanding devices, and controls the execution of the external job and the scanning job by the compressing/expanding devices depending on the discrimination result.

Priority is claimed to Japanese Patent Application No. 2003-298383, filed on Aug. 22, 2003, the disclosure of which is incorporated by reference in its entirety.

### BACKGROUND OF THE INVENTION

1. Field of the Invention

The present invention relates to a data processing apparatus and a data processing method preferably used in MFPs (Multi Function Peripherals) having a plurality of functions such as a copy function, a printer function, a scanner function and a facsimile function.

2. Description of Related Art

The following description sets forth the inventor's knowledge of related art and problems therein and should not be construed as an admission of knowledge in the prior art.

MFPs as mentioned above are provided with a plurality of input means to execute the aforementioned multiple functions. The examples of such input means include a receiving portion for receiving a job sent from an external apparatus such as a personal computer via a network, a receiving portion for receiving a facsimile (FAX) job transmitted from an external apparatus such as a FAX apparatus via a communication line network, and an original reading portion for reading originals.

MFPs are further provided with a printer portion for printing, for example, image data read by the aforementioned original reading portion and/or job data transmitted from the aforementioned external apparatus and a transmitting portion for transmitting the image data or the like read by the aforementioned original reading portion to the outside. Furthermore, MFPs are provided with a file memory for storing data inputted from each inputting means.

For the purpose of decreasing the storage capacity of the data to be stored in the file memory, in general, a compressing/expanding device for compressing/expanding data is provided. Inputted data is transferred to the compressing/expanding device to be compressed, and then this compressed data is stored in the file memory.

In these MFPs, it is sometimes the case that, during the compression processing or expansion processing of a job (external job) transmitted from the outside, a request for activating a scanning job to transmit the image data of the original read by the original reading portion to the outside and compressing or expanding the read image data with the compressing/expanding device is made.

In this case, however, there are the following drawbacks.

As methods for activating a scanning job, there are two methods, i.e., a method of activating the scanning job via an operational means such as an operation panel equipped to the MFP (hereinafter referred to as “on-site activation” method) and a method of activating the scanning job by an input from an external personal computer (hereinafter referred to as “remote activation” method). In the aforementioned case, since the external job is currently being executed, there is a problem that the user who made the on-site activation cannot bring back the original read by the original reading portion until the completion of the external job which is currently being executed.

To solve this problem, it can be considered that the processing of the currently processing external job and that of the requested scanning job by the compressing/expanding device are simply switched in turn so as to quickly complete the scanning job.

In this simple in-turn switching method, however, in cases where a scanning job is activated by a remote activation method, although it is not necessary for the user to wait in front of the MFP, the external job and the scanning job are executed in turn. Therefore, another drawback such as a deterioration of productivity of the external job arises.

Japanese Unexamined Laid-open Patent Publication No. 10-289074 discloses that the ordering of priority is given every job type in advance, if a job with higher priority is inputted during the execution of the current job, the current job is interrupted to allow the execution of the job with higher priority.

Furthermore, U.S. Pat. No. 6,381,031 discloses that assignments of a compressing operation and an expanding operation of a plurality of compressing/expanding devices conneceted in parallel are changed depending on the amount of data to be outputted. For example, in cases where code data is read out of a file memory while thinning the code data or only the code data on even-numbered pages are to be outputted, the amount of data to be stored in the file memory is larger than that of the image data to be read. Accordingly, the number of compressing/expanding devices that perform the compressing operation is increased, and that performs the expanding operation is decreased. Furthermore, in the case of the so-called sort copy, for the first copy all of the compressing/expanding devices will be assigned to the compressing operation, and for the second copy and subsequent thereof half of the compressing/expanding devices will be assigned to the compressing operation and the expanding operation, respectively.

In the technique disclosed in the aforementioned documents, however, there is no technical concept recognizing the aforementioned problems in cases where during the execution of an external job by a compressing/expanding device a processing request for a scanning job by the compressing/expanding device is made wherein the scanning job is activated by the on-site activation method or a remote activation method. Therefore, they are not sufficient to solve the aforementioned problems.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

It is an object of the present invention to provide a data processing apparatus capable of quickly executing a scanning job activated by an on-site activation method in cases where processing of the scanning job by the compressing/expanding device is requested when an external job is being executed by the compressing/expanding device and also capable of preventing a deterioration of productivity of a print job by a scanning job activated by a remote activation method.

It is another object of the present invention to provide a data processing method capable of quickly executing a scanning job activated by an on-site activation method in cases where processing of the scanning job by the compressing/expanding device is requested when an external job is being executed by the compressing/expanding device and also capable of preventing a deterioration of productivity of a print job by a scanning job activated by a remote activation method.

According to a first aspect of the present invention, a data processing apparatus includes an image reader for reading an original, a receiver capable of receiving an external job transmitted from an outside, a transmitter capable of transmitting image data of the original read by the image reader as a scanning job to an outside, a print device for printing data of the external job received by the receiver, one or a plurality of compressing/expanding devices for compressing the image data of the scanning job or the data of the external job and expanding the compressed data, an operation device for instructing an activation of the scanning job in accordance with an operation of a user, and a controller that discriminates whether an activation instruction of the scanning job is made by the operation device or from an outside in cases where a request for processing the image data of the scanning job by the one or a plurality of compressing/expanding devices is made when the data of the external job is being compressed or expanded by the one or a plurality of compressing/expanding devices, and controls execution of the external job and the scanning job by the one or a plurality of compressing/expanding devices depending on the discrimination result.

According to a second aspect of the present invention, a data processing method, comprising the steps of: reading an original by an image reader; receiving an external job transmitted from an outside; transmitting image data of the original read by the image reader to an outside as a scanning job; printing received data of the external job; and discriminating whether an activation instruction of the scanning job is made by an operation device of its apparatus or from an outside when a request for processing data of the scanning job by one or a plurality of compressing/expanding devices when the data of the external job is currently being compressed or expanded by one or a plurality of compressing/expanding devices, and controls the execution of the external job and that of the scanning job by one or plurality of compressing/expanding devices depending on the discrimination result.

According to a third aspect of the present invention, a data processing apparatus includes an image reader for reading an original, a receiver capable of receiving an external job transmitted from an outside, a transmitter capable of transmitting an image data of the original read by the image reader as a scanning job to an outside, a compressing/expanding device for compressing data and expanding the compressed data, an operation device for instructing an activation of the scanning job in accordance with an operation of a user, and a controller that discriminates whether the activation instruction of the scanning job is made by the operation device or from an outside in cases where a request for processing the image data of the scanning job by the compressing/expanding device is made when data of the external job is currently being compressed or expanded by the compressing/expanding device, and controls execution of the external job and that of the scanning job by the compressing/expanding device depending on the discrimination result.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspects or features of other embodiments where applicable. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the invention or various other embodiments, wherein:

FIG. 1 is a block diagram showing the structure of a data processing apparatus according to an embodiment of the present invention;

FIG. 2 is a flowchart showing the contents of the switching processing of the compressing/expanding devices in the data processing apparatus shown in FIG. 1;

FIG. 3 is a flowchart showing the contents of the switching judgment processing at S103 in the flowchart shown in FIG. 2;

FIG. 4 is a flowchart showing the contents of the in-turn switching processing at S231 and the print-job-priority switching processing at S241 in the flowchart shown in FIG. 3;

FIG. 5 is a flowchart showing another example of parallel processing for an external job and a scanning job; and

FIGS. 6A and 6B are explanatory drawings for explaining the contents of an on-site activation and a remote activation of the scanning job.

### DETAILED DESCRIPTION OF THE PREFERRED EMBODIMENTS

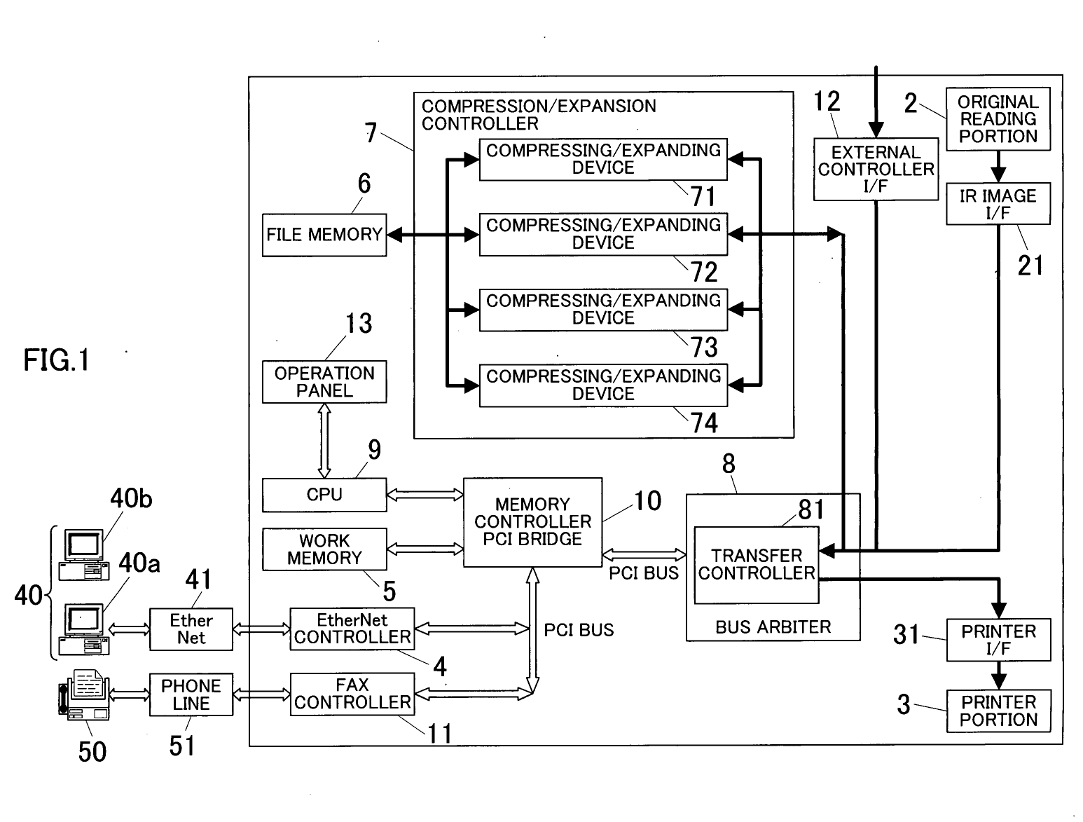

FIG. 1 shows a block diagram of a MFP1 as a data processing apparatus according to an embodiment of the present invention.

This data processing apparatus is provided with a plurality of input means and a plurality of output means. In detail, this apparatus is provided with an original reading portion 2 as an input means, an external controller interface portion 12 (external controller I/F in FIG. 1) as an input means, a printer portion 3 as an output means (printing means), an EtherNet controller 4 which functions as both an input means and an output means, and a FAX controller 11 which functions as both an input means and an output means.

The original reading portion 2 is provided with a scanner for reading out an original, and the image data read out from the original is sent to a bus arbiter 8 via a read-image interface portion 21(IR IMAGE I/F in FIG. 1).

The external controller Interface 12 receives a print job from an external printer controller (not shown). The printer portion 3 prints the image data transferred from the bus arbiter 8 on a paper or the like.

The EtherNet controller 4 receives/transmits a job via an EtherNet 41. For example, the EtherNet controller 4 receives a job transmitted from external devices 40 such as a user personal computer 40a, a personal computer servers 40b and an internet FAX device via the Ethernet 41 and/or an internet FAX job, or transmits the image data of an original read with the original reading portion 2 to the external devices 40 via the EtherNet 41.

The FAX controller 11 receives/transmits a FAX job between an external FAX device 50 and the MFP1 via a phone line 51. For example, the FAX controller 11 receives a FAX job transmitted from the external FAX device 50 via the phone line 51 or faxes the original image data read by the original reading portion 2 to the external FAX device 50 via the phone line 51.

The MFP1 is provided with a work memory 5, a file memory 6, a compression/expansion controller 7, the aforementioned bus arbiter 8, a CPU 9, a memory controller PCI bridge 10 and an operation panel 13.

The work memory 5 develops data-to-be-outputted such as the data contained in the job received by the EtherNet controller 4 or the external controller I/F 12, the data contained in the FAX receive job received by the FAX controller 11 and the image data read by the original reading portion 2, and stores another data.

The compression/expansion controller 7 of this embodiment is provided with a total of four compressing/expanding devices (compressors/expanders) 71 to 74 connected in parallel with each other and controls these compressing/expanding devices 71 to 74 so that the compression and expansion of the data-to-be-outputted is performed by the compressing/expanding devices 71 to 74. Each of the compressing/expanding devices 71 to 74 can perform a compressing operation or an expanding operation selectively.

The file memory 6 stores the data-to-be-outputted compressed by the compressing/expanding devices 71 to 74.

The bus arbiter 8 transfers the data-to-be-outputted to each portion in the MFP by a transfer controller 81.

The memory controller PCI bridge 10 controls the input and output status to the work memory 5 and connects the CPU bus and the PCI bus.

The CPU 9 controls the entire MFP 1 including the memory controller PCI bridge 10, the transfer controller 81, the compression/expansion controller 7. For example, the CPU 9 controls the operation of the compressing/expanding devices 71 to 74 via the compression/expansion controller 7. The CPU 9 has another various functions. For example, the CPU 9 has a function of discriminating whether there is a request to compress or expand scanning job data when job data transmitted from the outside is being compressed or expanded. Furthermore, the CPU 9 functions as a scanning job instruction origin discrimination means that discriminates whether the activation instruction of the scanning job is made by an operation of the operation panel 13 (on-site activation) or by a user personal computer 40a or the like (remote activation).

The scanning job mentioned in this specification means a job that transmits the image data of the original read by the original reading portion 2 to the outside. This job can be activated by an on-site activation method or by a remote activation method, as explained above.

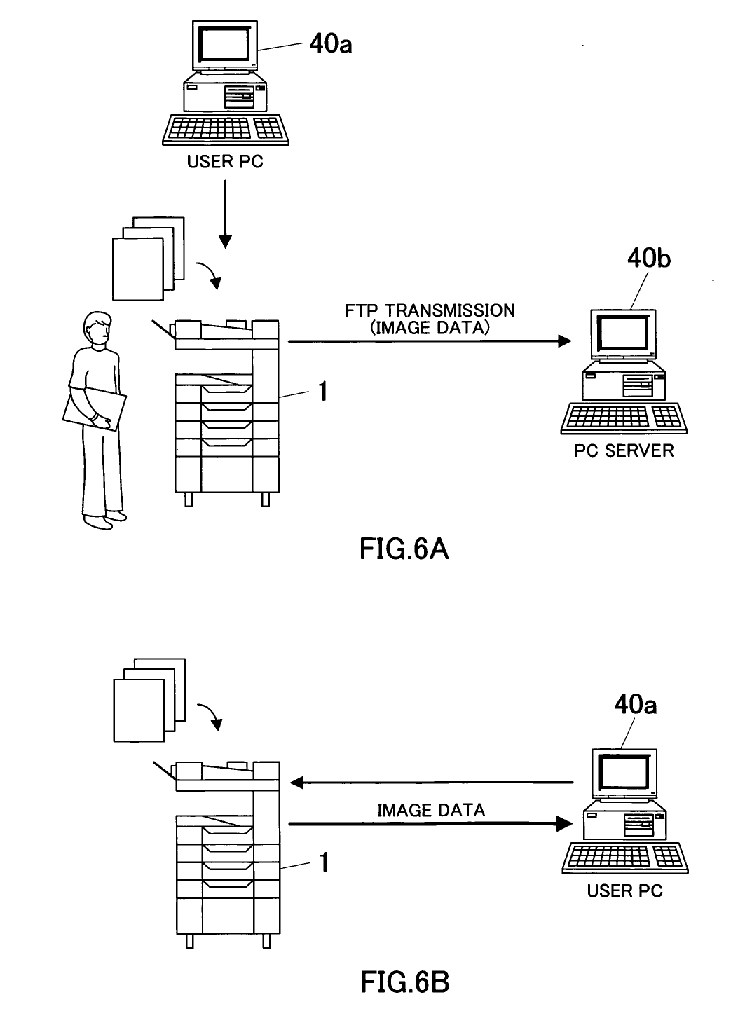

FIG. 6 shows an instruction flow of a scanning job and the data flow thereof. FIG. 6A shows both cases of the on-site activation and the remote activation in which the original image data read by the original reading portion 2 is FTP-transmitted to the personal computer server 40b (PC server in FIG. 6A) via the EtherNet 41. In the case of the remote activation, the scanning job is activated by a user via the user PC 40a. In this operation, the user specifies the destination address or the like using the exclusive software at the user PC 40a after setting the original on the original reading portion 2. On the other hand, in the case of the on-site activation, the user sets the scanning mode, the destination address or the like at the operation panel 13 after setting the original on the original reading portion 2. The read original image data is FTP-transmitted to the PC server 40b.

FIG. 6B shows the case in which a user who set the original on the original reading portion 2 sets a scanning mode and gives a scanning start instruction via, for example, a network TWAIN driver at the side of the user PC 40a to obtain the image data into his/her own user PC 40a.

The operation panel 13 functions as an operation means for instructing the scanning job by the on-site activation as mentioned above, and is provided with scan job mode setting keys, a scan start key, ten keys, various touch keys, a display portion, etc.

Executable jobs of the MFP1 shown in FIG. 1 include a copy job, a scan job, an internal printer job (including an internet FAX receive job), an external controller print job, a FAX transmission job and a FAX receive job. Among these jobs, as the external jobs which will be transmitted from the outside, there are an internal printer job, an external controller print job and a FAX receive job. As for the data flow of each job, there are a data input and a data output.

The data flow of each job will be explained as follows.

[Data Input]

As for a copy job, a scan job and a FAX transmission job, the image read by the original reading portion 2 is transferred to the work memory 5 via the read-image interface 21 and then to the compressing/expanding devices 71 to 74 to be compressed, and then stored in the file memory 6.

As for an internal printer job, the print data transmitted from the external device 40 via the EtherNet 41 is received by the EtherNet controller 4 and developed in the work memory 5, then transferred to the compressing/expanding devices 71 to 74 to be compressed, and then stored in the file memory 6.

As for a FAX receive job, the image data transmitted from the external FAX apparatus 50 via the phone line 51 is received by the FAX controller 11, transferred to the work memory 5, transferred to the compressing/expanding devices 71 to 74 to be compressed, and then stored in the file memory 6.

As for an external controller print job, the print data transmitted from the external controller is received by the external controller interface 12, transferred to the work memory 5 and then to the compressing/expanding devices 71 to 74 to be compressed, and then stored in the file memory 6.

[Data Output]

As for a copy job, an internal printer job, an external controller print job and a FAX receive job, the compressed data read out of the file memory 6 is expanded by the compressing/expanding devices 71 to 74 and transferred to the printer portion 3 via the work memory 5 and the printer interface 31 to be printed.

As for a scanning job, the compressed data read out of the file memory 6 is expanded by the compressing/expanding devices 71 to 74, transferred to the EtherNet controller 4 via the work memory 5 and then transmitted to the external device 40 such as the user personal computer 40a or the server 40b.

As for a FAX transmission job, the compressed data read out of the file memory 6 is expanded by the compressing/expanding devices 71 to 74, transferred to the FAX controller 11 via the work memory 5 and then transmitted to the external FAX device 50 via the phone line 51.

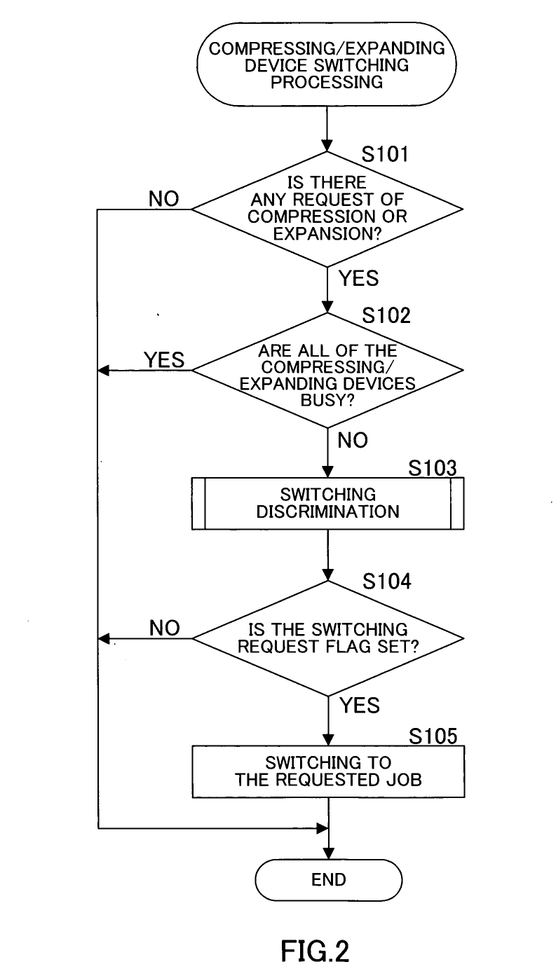

The contents of processing for switching the compressing/expanding devices to be performed by the CPU 9 when a request of a scanning job to be processed by the compressing/expanding devices 71 to 74 is made when a certain external job is being executed by the compressing/expanding devices 71 to 74 in the MFP1 shown in FIG. 1 are explained with reference to the flowchart shown in FIG. 2. In the following explanation, the external job will be referred to as a “print job.”

It is assumed that this processing will be called every time when a certain job activates the compressing/expanding processing or when processing by the compressing/expanding devices 71 to 74 is completed.

First, at S101, the CPU 9 discriminates whether there is a compression request or an expansion request. If there is no request (No at S101), the processing is terminated. If there is a request (Yes at S101), the routine proceeds to S102 to discriminate whether all of the compressing/expanding devices 71 to 74 are currently being used (i.e., busy).

At S102, if all of the compressing/expanding devices are busy (Yes at S102), since the switching is impossible, the routine terminates to hold the processing until the completion of the current processing by the compressing/expanding devices 71 to 74.

At S102, if all of them are not busy (No at S102), a subroutine for a switching discrimination processing is called at S103. As a result of discrimination in this subroutine considering various conditions, if it is discriminated that the compressing/expanding devices 71 to 74 can be used for a requested job, a switching request flag will be set and returned. This subroutine will be detailed later.

Next, at S104, it is discriminated from the output at the subroutine at S103 whether a switching request flag is set. If the flag is set (Yes at S104), switching processing to the requested job is performed at S105. If the switching request flag is not set (No at S104), the routine terminates to hold the switching to the requested job.

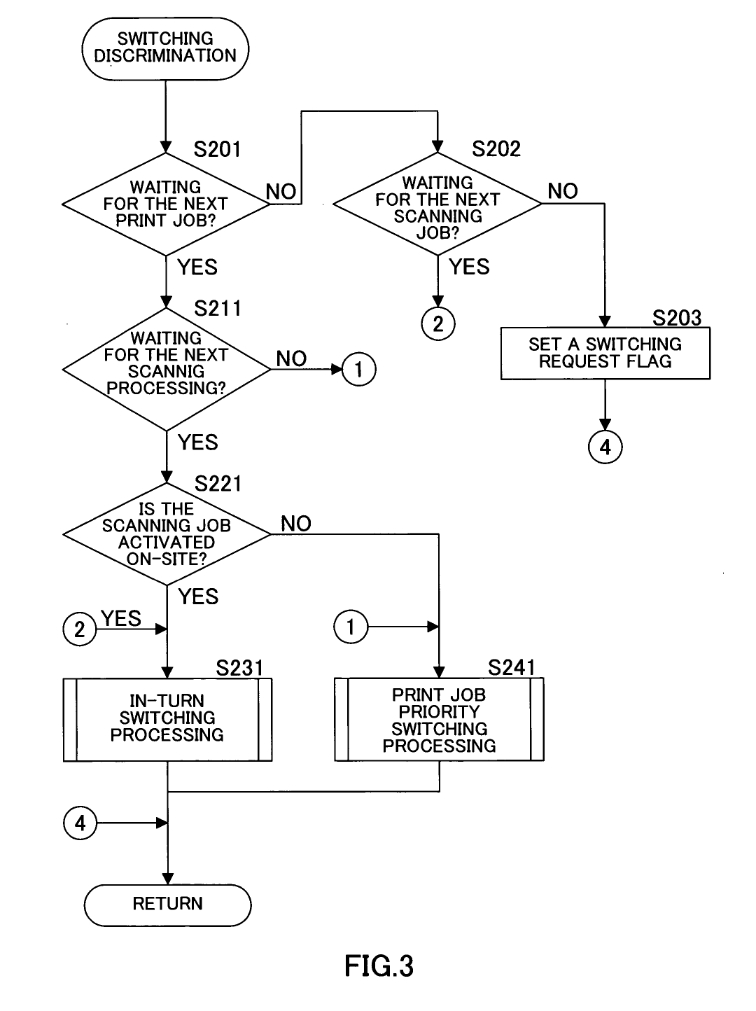

The contents of the subroutine of the switching discrimination processing at S103 in FIG. 2 are shown in the flowchart in FIG. 3.

In FIG. 3, at S201, it is discriminated whether the print job which is being currently executed is in a waiting status as a next job (hereinafter, “next print job processing waiting status”). If it is in the next print job processing waiting status (Yes at S201), at S211, it is discriminated whether a scanning job is in a waiting status as a next job (hereinafter, “next scanning job processing waiting status”).

If it is in the next scanning job processing waiting status (Yes at S211), in other words, if both of the print job and the scanning job are in a waiting status, the routine proceeds to S221 to perform a multi-access control depending on the instruction origin of the scanning job.

At S201, if it is not in the next print job processing waiting status (No at S201), it is discriminated whether it is in the next scanning job processing waiting status at S202. If it is in the next scanning job processing waiting status (Yes at S202), the in-turn switching processing (S231) (which will be detailed later) is performed, and then the routine returns. If it is not in the scanning job processing waiting status at S202 (No at S202), since a compression or expansion request is generated in a state in which a new job is activated when no job is currently in an operation status, the switching flag is set without condition at S203 and the routine returns.

At S211, if it is not in the next scanning job processing waiting status (No at S211), the print job priority switching processing is executed at S241 and then the routine returns.

Hereinafter, the aforementioned multi-access control depending on the instruction origin of the scanning job is detailed.

At S221, it is discriminated whether the activation of the scanning job is the on-site activation made by the operation of the main body operation panel 13. If it is the on-site activation (Yes at S221), at S231, the subroutine of the in-turn switching processing is called. If it is not the on-site activation (No at S221), in other words, if it is a remote activation from a personal computer or the like, at S241, the subroutine of the print job priority switching processing is called.

According to the aforementioned processing, in the case of the on-site activation the scanning job and the print job are performed in turn, and in the case of the remote activation the print job is performed with priority.

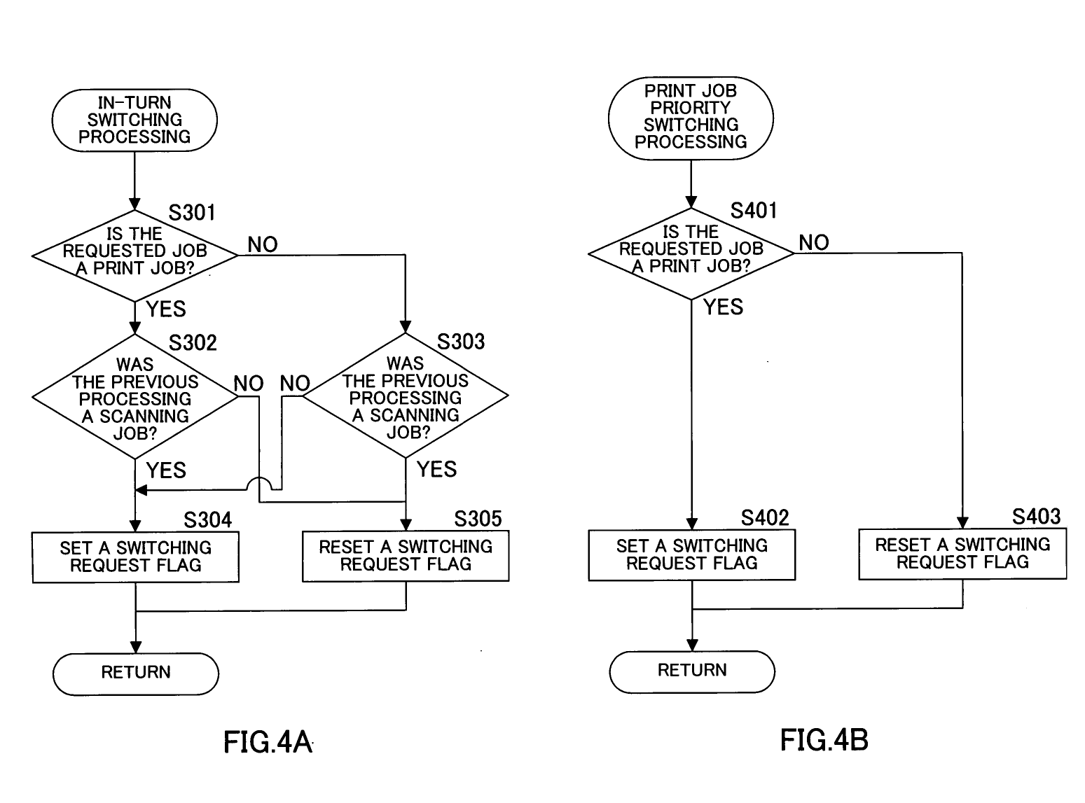

The flowchart of the subroutine of the aforementioned in-turn switching processing (S231) and that of the print job priority switching processing (S241) are shown in FIG. 4A and FIG. 4B, respectively.

In the in-turn switching processing shown in FIG. 4A, the processing of the print job and that of the scanning job are executed in turn. First, at S301, it is discriminated whether the requested job is a print job. If it is a print job (Yes at S301), at S302, it is discriminated whether the previous processing was a compression or expansion processing of a scanning job. If it was a scanning job (Yes at S302), the routine proceeds to S304 to switch the processing from a scanning job to a print job, and a switching request flag is set.

At S302, if it was not a scanning job (No at S302), since the previous job was also a print job, the next processing should be a scanning job. Therefore, the switching flag is reset at S305.

At S301, if the requested job is not a print job, in other words, if the requested job is a scanning job (No at S301), at S303, it is discriminated whether the previous processing was scanning job compression or expansion processing. If it was not scanning job processing (No at S303), the routine proceeds to S304 to switch the processing from the print job to a scanning job. Then, a switching request flag is set.

At S303, if it was scanning job processing (Yes at S303), since the previous processing was also scanning job processing, the next processing should be print job processing. Therefore, at S305, a switching flag is reset.

In the print job priority switching processing shown in FIG. 4B, at S401, it is discriminated whether the requested job is a print job. If it is a print job (Yes at S401), at S402, a switching request flag is set. If it is not a print job (No at S401), at S403, a switching request flag is reset.

In other words, in this print job priority switching processing, a switching request flag is set only when the requested job is a print job and reset when it is not a print job, so that only a request for compressing or expanding a print job is accepted to thereby preferentially execute the processing of the print job.

As mentioned above, in cases where a request for using the compressing/expanding devices 71 to 74 for a scanning job is made when a print job is currently being executed, only when the activation of the scanning job is the on-site activation, parallel processing by the in-turn switching processing of the print job and the scanning job is performed. Therefore, the processing of the scanning job can be performed quickly, resulting in a short waiting time for a user who activated the scanning job by the on-site activation.

On the other hand, in the case of the remote activation, since a print job is preferentially performed, the productivity of the print job does not deteriorate.

In the embodiment shown in FIG. 4, the processing by the compressing/expanding devices 71 to 74 is performed by switching the processing in turn as a parallel processing of a print job and a scanning job. However, the print job and the scanning job can be performed in parallel by simultaneously executing these jobs by switching the operational assignment of the four compressing/expanding devices 71 to 74.

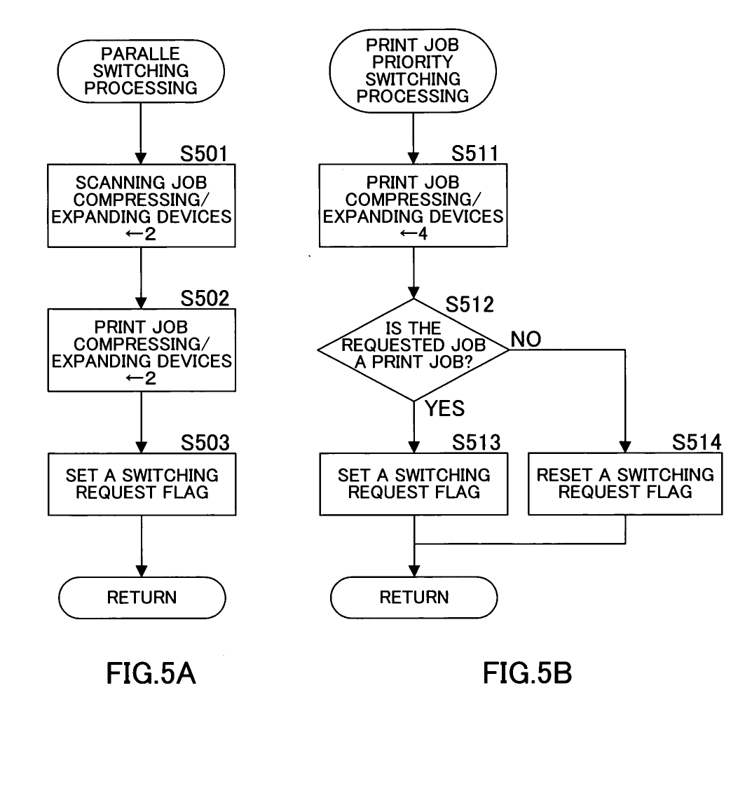

FIG. 5 shows such parallel processing. FIG. 5A is a flowchart showing the subroutine of the parallel switching processing and FIG. 5B is a flowchart showing the subroutine of the print job priority switching processing.

The parallel switching processing shown in FIG. 5A corresponds to the in-turn switching processing at S231 shown in FIG. 3, and the print job priority switching processing shown in FIG. 5B corresponds to the print job priority switching processing at S241 shown in FIG. 3.

In the parallel switching processing shown in FIG. 5A, two compressing/expanding devices among a total of four compressing/expanding devices are assigned to the print job and the scanning job, respectively. First, at S501, two compressing/expanding devices to be used for the scanning job are assigned. Furthermore, at S502, two compressing/expanding devices to be used for the print job are assigned. Then, at S503, a switching request flag is set. By this switching request, in the switching processing to the requested job at S105 shown in FIG. 2, the requests for these two jobs are activated simultaneously.

On the other hand, in the print job priority switching processing shown in FIG. 5B, at S511, four compressing/expanding devices to be used for the print job are assigned. At S512, it is discriminated whether the requested job is a print job. If it is a print job (Yes at S512), at S513, a switching request flag is set. If it is not a print job (No at S512), a switching request flag is reset.

In other words, a switching request flag is set only when the requested job is a print job and reset when the request job is not a print job, so that only a request for compressing or expanding a print is accepted to preferentially execute the print job.

In cases where it is initialized at the time of turning on a power and where there exist only one request to execute a scanning job or a print job, all of the four compressing/expanding devices are assigned to the scanning job and the print job, respectively.

In the aforementioned embodiment, in order to perform the processing of the scanning job and that of the print job in parallel, two compressing/expanding devices are assigned to each job. However, only one device can be assigned to each job, or the assignment number of the devices to each job can be changed.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

1. A data processing apparatus, comprising:
an image reader for reading an original;
a receiver capable of receiving an external job transmitted from an outside;
a transmitter capable of transmitting image data of the original read by said image reader as a scanning job to an outside;
a print device for printing data of the external job received by said receiver;
one or a plurality of compressing/expanding devices for compressing the image data of the scanning job or the data of the external job and expanding the compressed data;
an operation device for instructing an activation of the scanning job in accordance with an operation of a user; and
a controller that discriminates whether an activation instruction of the scanning job is made by said operation device or from an outside in cases where a request for processing the image data of the scanning job by said one or a plurality of compressing/expanding devices is made when the data of the external job is being compressed or expanded by said one or a plurality of compressing/expanding devices, and controls execution of the external job and the scanning job by said one or a plurality of compressing/expanding devices depending on the discrimination result.

2. The data processing apparatus as recited in claim 1, wherein said controller makes said one or plurality of compressing/expanding devices execute processing of the external job and that of the scanning job in parallel when it is discriminated that the activation instruction of the scanning job is made by said operation device.

3. The data processing apparatus as recited in claim 2, wherein said controller makes said one or plurality of compressing/expanding devices execute the processing of the external job and that of the scanning job in parallel by switching the processing of the external job and that of the scanning job in turn.

4. The data processing apparatus as recited in claim 2, wherein said controller assigns at least one of said plurality of compressing/expanding devices to the processing of the external job and that of the scanning job, respectively, to thereby execute these processing in parallel.

5. The data processing apparatus as recited in claim 1, wherein said controller makes said one or plurality of compressing/expanding devices execute the processing of the scanning job after a completion of the processing of the external job when it is discriminated that the activation instruction of the scanning job is made from an outside.

6. A data processing method, comprising the steps of:
reading an original by an image reader;
receiving an external job transmitted from an outside;
transmitting image data of the original read by the image reader to an outside as a scanning job;
printing received data of the external job; and
discriminating whether an activation instruction of the scanning job is made by an operation device of its apparatus or from an outside when a request for processing data of the scanning job by one or a plurality of compressing/expanding devices when the data of the external job is currently being compressed or expanded by one or a plurality of compressing/expanding devices, and controls the execution of the external job and that of the scanning job by one or plurality of compressing/expanding devices depending on the discrimination result.

7. The data processing method as recited in claim 6, wherein processing of the external job and that of the scanning job by the one or a plurality of compressing/expanding devices are executed in parallel when it is discriminated that the activation instruction of the scanning job is made by the operation device of its apparatus.

8. The data processing method as recited in claim 7, wherein the processing of the external job and that of the scanning job by the one or a plurality of compressing/expanding devices are executed in parallel by switching these processing in turn when it is discriminated that the activation instruction of the scanning job is made by the operation device of its apparatus.

9. The data processing method as recited in claim 7, wherein the processing of the external job and that of the scanning job are executed in parallel by assigning at least one of plurality of compressing/expanding devices to the processing of the external job and that of the scanning job, respectively.

10. The data processing method as recited in claim 6, wherein the processing of the scanning job is executed after the completion of the processing of the external job when it is discriminated that the activation instruction of the scanning job is made from an outside.

11. A data processing apparatus, comprising:
an image reader for reading an original;
a receiver capable of receiving an external job transmitted from an outside;
a transmitter capable of transmitting an image data of the original read by said image reader as a scanning job to an outside;
a compressing/expanding device for compressing data and expanding the compressed data;
an operation device for instructing an activation of the scanning job in accordance with an operation of a user; and
a controller that discriminates whether the activation instruction of the scanning job is made by said operation device or from an outside in cases where a request for processing the image data of the scanning job by said compressing/expanding device is made when data of the external job is currently being compressed or expanded by said compressing/expanding device, and controls execution of the external job and that of the scanning job by said compressing/expanding device depending on the discrimination result.

12. The data processing apparatus as recited in claim 11, wherein said controller makes said compressing/expanding device execute the processing of the external job and that of the scanning job in parallel in case where it is discriminated that the activation instruction of the scanning job is made by said operation device.

13. The data processing apparatus as recited in claim 12, wherein said controller makes said compressing/expanding device execute the processing of the external job and that of the scanning job in parallel by switching the processing of the external job and that of the scanning job in turn.

14. The data processing apparatus as recited in claim 12, wherein said compressing/expanding device includes a plurality of compressors/expanders, and wherein said controller assigns at least one of said plurality of compressors/expanders to the processing of the external job and that of the scanning job, respectively, to thereby execute these processing in parallel.

15. The data processing apparatus as recited in claim 11, wherein said controller makes said compressing/expanding device execute the processing of the scanning job after a completion of the processing of the external job when it is discriminated that the activation instruction of the scanning job is made from an outside.

16. The data processing apparatus as recited in claim 11, further comprising:
a print device for printing the data of the external job received by said receiver.
